(19) United States
(12) Patent Application Publication
(10) Pub. No.: US 2026/0351934 A1
(43) Pub. Date: Nov. 5, 2026

(54) CABLE COMB AND CABLE ASSEMBLY USING THE SAME

(71) Applicant: BIZLINK INTERNATIONAL CORP., New Taipei City (TW)

(72) Inventors: Pengfei MAO, New Taipei City (TW); Xiangwu WANG, New Taipei City (TW); Zhenge HUANG, New Taipei City (TW)

(21) Appl. No.: 19/661,716

(22) Filed: Apr. 29, 2026

(30) Foreign Application Priority Data
Apr. 30, 2025 (CN) 202520861793.X

(51) Int. Cl. H02G 3/04

(52) U.S. Cl. CPC H02G 3/0456

(57) ABSTRACT

A cable comb is provided. The cable comb includes a separator board. The separator board includes a plurality of first partitioning walls disposed on a first surface of the separator board to define a plurality of first channels. The first channels include a central channel and two side channels located on opposite sides of the central channel. The central channel tapers from an inlet end to an outlet end, and the first partitioning walls of the side channels converge toward a center along a tapering contour of the central channel.

This application claims priority to China Application Serial Number 202520861793.X, filed Apr. 30, 2025, which is herein incorporated by reference in its entirety.

### BACKGROUND

### Field of Invention

The present disclosure relates to the field of electrical connector technologies. More particularly, the present disclosure relates to a cable comb and a cable assembly utilizing the same.

### Description of Related Art

High-current connectors serve as a crucial foundation for industrial power transmission systems. Proper selection and structural design of high-current connectors are essential to ensure the efficient, safe, and stable operation of power systems. Generally, a cable assembly consists of a head connector and a tail connector disposed at two opposite ends, as well as a power supply wiring harness connected therebetween. To meet the specific demands of high-current transmission, the power supply wiring harness typically includes one or more thick power cables.

However, when the power supply wiring harness of the high-current connector includes a plurality of power cables, strict requirements are imposed on the alignment and specific connection positions between the individual power cables and the corresponding terminals of the head connector or the tail connector. In conventional assembly processes, when the power supply wiring harness is delivered to an assembly station, the multiple thick power cables are often scattered, entangled, or disorganized. This disorganized state of the power cables makes it difficult for operators or automated equipment to align them properly, thereby rendering the overall connection and assembly process complex, inefficient, and difficult.

Therefore, there is a need to provide an improved cable comb and a cable assembly to overcome the aforementioned deficiencies in the related art.

### SUMMARY

The present disclosure relates to a cable comb and a cable assembly effectively routing and organizing multiple power cables, thereby streamlining the wiring management and simplifying the subsequent assembly processes with a head connector and a tail connector.

According to one aspect of the present disclosure, a cable comb is provided. The cable comb comprises a separator board. The separator board comprises a plurality of first partitioning walls disposed on a first surface of the separator board to define a plurality of first channels. The first channels include a central channel and two side channels located on opposite sides of the central channel. The central channel tapers from an inlet end to an outlet end, and the first partitioning walls of the side channels converge toward a center along a tapering contour of the central channel.

According to another aspect of the present disclosure, a cable assembly is provided. The cable assembly comprises a head connector, a tail connector, a plurality of power cables connected between the head connector and the tail connector, and the aforementioned cable comb. The power cables are respectively embedded in the first channels of the cable comb.

In some embodiments, the cable comb and the cable assembly of the present disclosure are capable of accommodating scattered and disorganized power cables and arranging them in a neat and orderly manner. Specifically, the structurally tailored design of the tapering and converging first channels is configured to potentially guide the power cables along specific directions and adjust their relative spacing. Therefore, the structures of the present disclosure can significantly eliminate the clutter of power cables, ensure correct spatial arrangements, and facilitate accurate and efficient docking with the head connector or the tail connector.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a first perspective view of a cable comb in accordance with an embodiment of the present disclosure;

FIG. 2 is a second perspective view of the cable comb in accordance with an embodiment of the present disclosure, showing a view from an angle different from FIG. 1;

FIG. 3 is a perspective view showing the cable comb in a usage state with power cables in accordance with an embodiment of the present disclosure;

FIG. 4 is a view of the cable comb and the power cables in the usage state looking from the inlet end in accordance with an embodiment of the present disclosure; and

FIG. 5 is a view of the cable comb and the power cables in the usage state looking from the outlet end in accordance with an embodiment of the present disclosure.

### DETAILED DESCRIPTION

The following description of the detailed embodiments is merely exemplary in nature and is in no way intended to limit the present disclosure, its application, or uses. Reference will now be made in detail to the present embodiments of the invention, examples of which are illustrated in the accompanying drawings. Wherever possible, the same reference numbers are used in the drawings and the description to refer to the same or like parts.

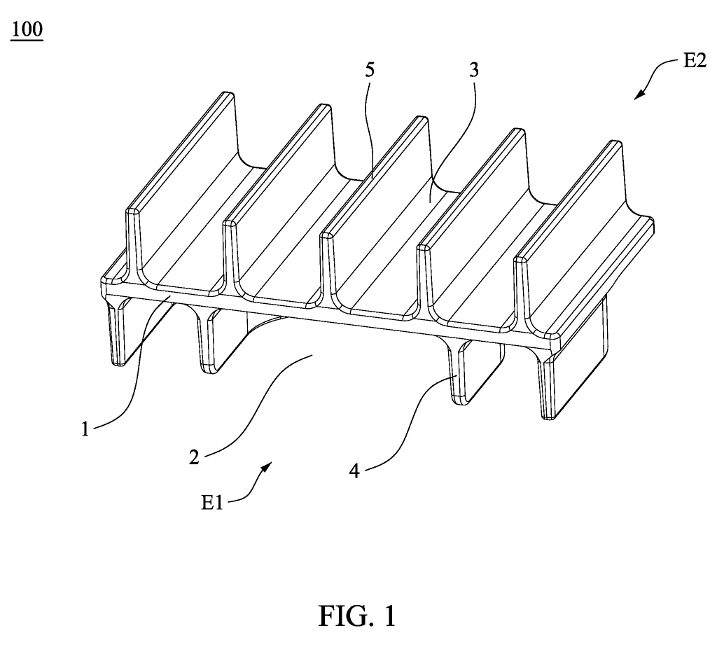

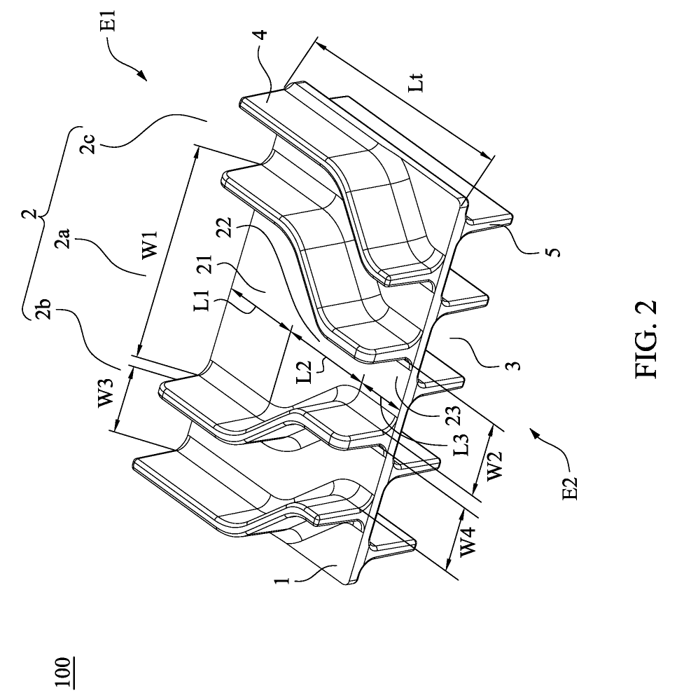

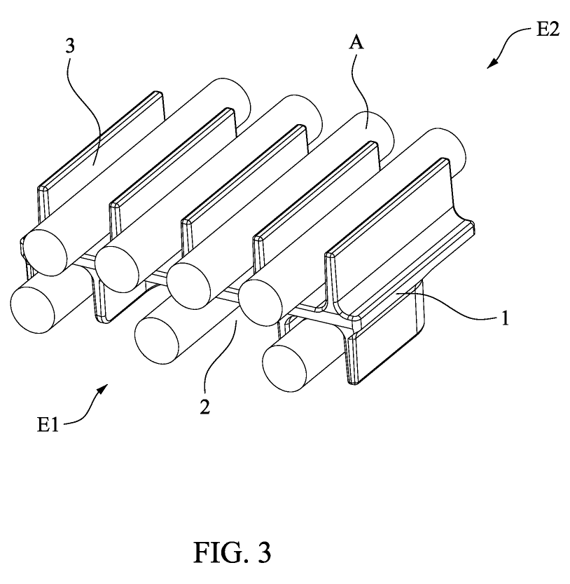

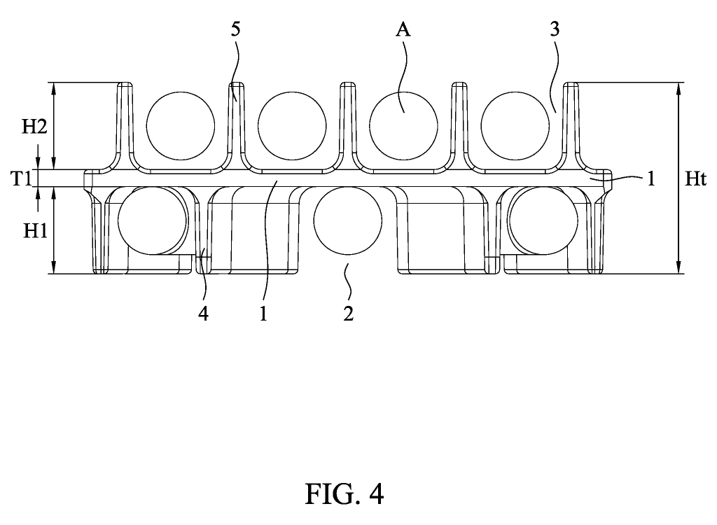

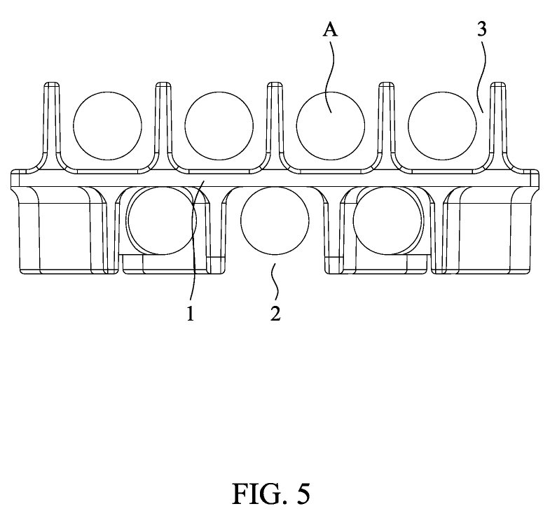

Referring generally to FIGS. 1 - 5, the present disclosure provides a cable comb 100 and a cable assembly utilizing the same. Among the drawings, FIGS. 1 and 2 illustrate perspective views of the cable comb 100, while FIG. 3 illustrates the cable assembly in a usage state. Furthermore, FIG. 4 is a view of the cable comb in the usage state of FIG. 3 looking from an inlet side, and FIG. 5 is a view of the cable comb in the usage state of FIG. 3 looking from an outlet side.

Referring to FIGS. 1 and 2, the cable comb 100 comprises a separator board 1. The separator board 1 comprises a first surface (e.g., a lower surface) and a second surface (e.g., an upper surface) opposite to the first surface. A plurality of first partitioning walls 4 are disposed on the first surface to define a plurality of first channels 2. Similarly, a plurality of second partitioning walls 5 are disposed on the second surface to define a plurality of second channels 3. Specifically, the plurality of second partitioning walls 5 extend linearly from an inlet end E1 to an outlet end E2 of the cable comb 100, and are parallel to each other. Accordingly, each of the second channels 3 has a uniform cross-sectional width (also referred to as uniform rectangular channels). Furthermore, a quantity of the first channels 2 is three (i.e., an odd quantity), and a quantity of the second channels 3 is four (i,e., an even quantity). That is, the quantity of the first channels 2 is less than the quantity of the second channels 3. Additionally, the first channels 2 and the second channels 3 are each open-top channels that allow contents therein to be exposed.

In an embodiment, the separator board 1, the first partitioning walls 4, and the second partitioning walls 5 of the cable comb 100 may be integrally formed as a single-piece structure through an injection molding process using an insulating plastic material.

In some embodiments, this configuration facilitates the accommodation of different numbers of power cables on opposite sides of the cable comb 100. The asymmetrical quantity design (i.e., three first channels 2 and four second channels 3) is configured to potentially differentiate distinct types of electrical lines, thereby streamlining the wiring management and preventing misassembly during the manufacturing process.

Referring to FIGS. 1 and 2, the first channels 2 include a central channel 2a (also referred to as first channel located at a middle position) and two side channels 2b, 2c (also referred to as left and right two first channels) located on opposite sides of the central channel 2a. Structurally, the central channel 2a tapers from the inlet end E1 to the outlet end E2, and the first partitioning walls 4 of the side channels 2b, 2c converge toward a center along a tapering contour of the central channel 2a. Regarding the specific width proportions, an inlet width W1 of the central channel 2a is at least twice an outlet width W2 of the central channel 2a. Additionally, each of the side channels 2b, 2c sequentially presents a narrow-wide-narrow profile from the inlet end E1 to the outlet end E2, and an inlet width W3 of each of the side channels 2b, 2c is respectively between 0.8 and 1.2 times an outlet width W4 thereof.

In an embodiment, the two side channels 2b, 2c are symmetrically disposed on the opposite sides of the central channel 2a to maintain a structurally balanced layout for wire routing.

In some embodiments, this configuration facilitates effectively routing and organizing the power cables. The tapering and converging structural design is configured to potentially gather scattered power cables. As will be further illustrated in the usage states (e.g., FIGS. 4 and 5), the power cables entering the wider inlet end E1 are smoothly guided by the first partitioning walls 4 toward the narrower outlet end E2. Consequently, this specific geometry significantly narrows the relative spacing between the power cables, ensuring an accurate and tight alignment for subsequent connections.

Still referring to FIGS. 1 and 2, the geometry of the first channels 2 can be further defined along the lengthwise direction. Specifically, the central channel 2a sequentially comprises, from the inlet end E1 to the outlet end E2, an inlet-side parallel extension section 21, a tapered transition section 22, and an outlet-side parallel extension section 23. Namely, Portions of the two first partitioning walls 4 adjacent to the inlet end E1 are arranged substantially parallel to each other to define the inlet-side parallel extension section 21; portions of the two first partitioning walls 4 adjacent to the outlet end E2 are arranged substantially parallel to each other to define the outlet-side parallel extension section 23; and portions of the two first partitioning walls 4 between the inlet end E1 and the outlet end E2 converge toward each other to define the tapered transition section 22. The cable comb 100 has a total length Lt defined from the inlet end E1 to the outlet end E2. To optimize the guiding effect, a length L1 of the inlet-side parallel extension section 21 is designed to be greater than a length L3 of the outlet-side parallel extension section 23. Specifically, the length L1 of the inlet-side parallel extension section 21 is at least 1.5 times the length L3 of the outlet-side parallel extension section 23. Moreover, a length L2 of the tapered transition section 22 is structurally configured to be between 40% and 50% of the total length Lt.

In an embodiment, the specific dimensions of these sections may be configured as follows to fit standard high-current connectors: the total length Lt of the cable comb 100 is between 30 mm and 40 mm, the length L1 is between 10 mm and 15 mm, the length L2 is between 15 mm and 20 mm, and the length L3 is between 5 mm and 10 mm.

In some embodiments, this configuration facilitates a smooth, staged, and precise wire routing process. The inlet-side parallel extension section 21 serves as an initial buffering zone to stably receive and align the inserted power cables; the tapered transition section 22 executes the primary converging action to gradually and safely reduce the wire spacing without causing excessive bending stress; and the outlet-side parallel extension section 23 ensures that the power cables are straightened and aligned parallel to each other before exiting, thereby facilitating an accurate and effortless mating process with the corresponding connector terminals.

Referring to the inlet-side and outlet-side views of FIGS. 4 and 5, which clearly illustrate the vertical dimensional characteristics of the cable comb 100. Structurally, a height Ht of the cable comb 100 is defined as a sum of a height H1 of the first partitioning walls 4, a thickness T1 of the separator board 1, and a height H2 of the second partitioning walls 5. Regarding the specific numerical ranges, the height Ht of the cable comb 100 is configured to be between 16 mm and 33 mm, and the height H1 of the first partitioning walls 4 is specifically between 7 mm and 13 mm.

In an embodiment, the thickness T1 of the separator board 1 may be dimensioned to provide adequate structural rigidity to prevent the cable comb 100 from bending or deforming under stress, while the heights H1 and H2 are tailored according to the specific outer diameters of the power cables A to be accommodated.

In some embodiments, this configuration facilitates securing and isolating the thick power cables A effectively. The precisely defined height ranges are configured to potentially ensure that the cable comb 100 remains compact enough to fit seamlessly within the limited internal housing space of a standard high-current connector. Simultaneously, the specified height H1 ensures that the first partitioning walls 4 are sufficiently tall to firmly embed the power cables A, thereby preventing them from popping out and avoiding potential electrical interference or short circuits between adjacent power cables.

Referring to FIG. 3, a cable assembly (also referred to as high-current connector) is further provided according to the present disclosure. The cable assembly comprises a head connector, a tail connector, a plurality of power cables A connected between the head connector and the tail connector, and the cable comb 100 as described in the previous embodiments. As illustrated in the usage state of FIG. 3, the power cables A are respectively embedded in the channels of the cable comb 100. Specifically, the plurality of power cables A includes three power cables A embedded in the first channels 2 and four power cables A embedded in the second channels 3.

In practical application, a plurality of cables are typically first soldered respectively into the recesses of corresponding cylindrical terminals. The terminals are then inserted from a rear side into respective terminal holes of an insulating plastic base of a connector. Meanwhile, in order to maintain positional arrangement of the cables, a cable comb 100 is provided at tail ends of interfaces between each cable and the corresponding terminal.

Subsequently, an insert molding process is performed to form an inner molded layer outside the base, so as to encapsulate a rear portion of the base, the interfaces between the cables and the terminals, and at least a majority of the cable comb. Thereafter, an outer molded layer is further formed outside the inner molded layer, thereby completing the connector.

It should be noted that the cable comb is not necessarily disposed within the connector. When required, it may alternatively be arranged within a cable segment between two connectors. In particular, when core wires of a cable are stripped and branched into a one-to-multiple configuration, the cable comb is particularly advantageous for isolation purposes in such configurations.

In an embodiment, the power cables A may be thick, heavy-duty conductive wires wrapped with insulating layers, and they can be securely retained within the first channels 2 and the second channels 3 via an interference fit or partial structural support provided by the partitioning walls 4, 5.

In some embodiments, this configuration facilitates a highly organized and robust wire management system for the cable assembly. By utilizing the structurally tailored cable comb 100, the previously scattered and disorganized power cables A are systematically guided and restrained. As the power cables a pass through the cable comb 100, especially being guided by the tapering and converging contours of the first channels 2, the sequence and direction of the power cables A are no longer messy or tangled. Consequently, this design ensures that each power cable A is precisely spaced and aligned, enabling an accurate, seamless, and efficient docking process with the corresponding terminals of the head connector or the tail connector.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A cable comb, comprising:
a separator board comprising a plurality of first partitioning walls disposed on a first surface of the separator board to define a plurality of first channels, the first channels including a central channel and two side channels located on opposite sides of the central channel;
wherein the central channel tapers from an inlet end to an outlet end, and the first partitioning walls of the side channels converge toward a center along a tapering contour of the central channel.

2. The cable comb of claim 1, wherein the central channel is defined by two of the plurality of first partitioning walls, portions of the two first partitioning walls adjacent to the inlet end are arranged substantially parallel to each other to define an inlet-side parallel extension section; portions of the two first partitioning walls adjacent to the outlet end are arranged substantially parallel to each other to define an outlet-side parallel extension section; and portions of the two first partitioning walls between the inlet end and the outlet end converge toward each other to define a tapered transition section.

3. The cable comb of claim 2, wherein a length of the inlet-side parallel extension section is greater than a length of the outlet-side parallel extension section.

4. The cable comb of claim 3, wherein the length of the inlet-side parallel extension section is at least 1.5 times the length of the outlet-side parallel extension section.

5. The cable comb of claim 2, wherein the cable comb has a total length from the inlet end to the outlet end, and a length of the tapered transition section is between 40% and 50% of the total length.

6. The cable comb of claim 5, wherein the total length is between 30 mm and 40 mm, a length of the inlet-side parallel extension section is between 10 mm and 15 mm, the length of the tapered transition section is between 15 mm and 20 mm, and a length of the outlet-side parallel extension section is between 5 mm and 10 mm.

7. The cable comb of claim 6, wherein an inlet width of the central channel is at least twice an outlet width of the central channel.

8. The cable comb of claim 1, wherein each of the side channels sequentially presents a narrow-wide-narrow profile from the inlet end to the outlet end, and an inlet width of each of the side channels is respectively between 0.8 and 1.2 times an outlet width thereof.

9. The cable comb of claim 1, wherein a plurality of second partitioning walls are disposed on a second surface of the separator board, the second surface being opposite to the first surface; and the plurality of second partitioning walls extend linearly from the inlet end to the outlet end, and are parallel to each other to define a plurality of second channels, and
wherein the first channels are in an odd quantity, the second channels are in an even quantity, and the first channels are fewer than the second channels, wherein the first channels and the second channels are each open-top channels that allow contents therein to be exposed.

10. The cable comb of claim 9, wherein a height of the cable comb is a sum of a height of the first partitioning walls, a thickness of the separator board, and a height of the second partitioning walls, and the height of the cable comb is between 16 mm and 33 mm.

11. The cable comb of claim 10, wherein the height of the first partitioning walls is between 7 mm and 13 mm.

12. The cable comb of claim 9, wherein each of the second channels has a uniform cross-sectional width.

13. The cable comb of claim 9, wherein a quantity of the first channels is three, a quantity of the second channels is four, and the two side channels are symmetrically disposed on the opposite sides of the central channel.

14. A cable assembly, comprising:
a head connector;
a tail connector;
a plurality of power cables connected between the head connector and the tail connector; and
the cable comb of claim 1;
wherein the power cables are respectively embedded in the first channels.

15. The cable assembly of claim 14, wherein the power cables embedded in the side channels are guided to move toward the power cable embedded in the central channel near the outlet end.

16. The cable assembly of claim 14, wherein a plurality of second channels linearly extending from the inlet end to the outlet end and parallel to each other are formed on a second surface of the separator board, the second surface being opposite to the first surface, and
wherein the plurality of power cables includes three power cables embedded in the first channels and four power cables embedded in the second channels.

17. The cable assembly of claim 14, wherein the central channel sequentially comprises, from the inlet end to the outlet end, an inlet-side parallel extension section, a tapered transition section, and an outlet-side parallel extension section.

18. The cable assembly of claim 17, wherein a total length of the cable comb from the inlet end to the outlet end is between 30 mm and 40 mm, a length of the inlet-side parallel extension section is between 10 mm and 15 mm, a length of the tapered transition section is between 15 mm and 20 mm, and a length of the outlet-side parallel extension section is between 5 mm and 10 mm;
a plurality of second partitioning walls are disposed on a second surface of the separator board, the second surface being opposite to the first surface;
the plurality of second partitioning walls extend linearly from the inlet end to the outlet end, and are parallel to each other to define a plurality of second channels;
a height of the cable comb is a sum of a height of the first partitioning walls, a thickness of the separator board, and a height of the second partitioning walls; and
the height of the cable comb is between 16 mm and 33 mm, and the height of the first partitioning walls is between 7 mm and 13 mm.

19. The cable assembly of claim 14, wherein an inlet width of the central channel is at least twice an outlet width of the central channel, and each of the side channels sequentially presents a narrow-wide-narrow profile from the inlet end to the outlet end, and an inlet width of each of the side channels is respectively between 0.8 and 1.2 times an outlet width thereof.
